(19) United States
(12) Patent Application Publication
(10) Pub. No.: US 2013/0263332 A1
(43) Pub. Date: Oct. 3, 2013

(54) INSPECTION APPARATUS AND METHOD FOR A MAGNETIC HEAD

(71) Applicant: HITACHI HIGH-TECHNOLOGIES CORPORATION, Tokyo (JP)

(72) Inventor: Shinji KAWAMOTO, Kamisato-machi (JP)

(73) Assignee: HITACHI HIGH-TECHNOLOGIES CORPORATION, Tokyo (JP)

(21) Appl. No.: 13/761,719

(22) Filed: Feb. 7, 2013

(30) Foreign Application Priority Data
Mar. 30, 2012 (JP) 2012-079621

(51) Int. Cl. G01Q 60/54

(52) U.S. Cl. CPC G01Q 60/54
USPC 850/48

(57) ABSTRACT

A signal for excitation is supplied to a connection terminal of a magnetic head. A magnetic probe of a magnetic force microscope is made to fly over the magnetic head and to scan a plurality of scan lines at predetermined intervals in parallel with one side of the magnetic head. A magnetic field strength of the magnetic head is detected to form magnetic field strength profiles of the scan lines. An effective magnetic field strength profile that brings about a magnetic effective track width of the magnetic head is extracted on the basis of a result of detection and the magnetic effective track width of the magnetic head is obtained on the basis of the effective magnetic field strength profile. After extraction of the effective magnetic field strength profile, a scan for obtaining the magnetic effective track width of the magnetic head is stopped.

### BACKGROUND OF THE INVENTION

1. Field of the Invention

The present invention relates to inspection apparatus and method for magnetic head for inspecting a thin film magnetic head, and more particularly to inspection apparatus and method for magnetic head allowing efficient inspection of a track width of the thin film magnetic head the inspection of which is difficult through an optical microscope.

2. Description of the Prior Art

As a technique for inspecting a track width of a thin film magnetic head, there is proposed a technique described, for example, in Japanese Patent Laid-Open No. 2009-230845. In the technique described in Japanese Patent Laid-Open No. 2009-230845, a record signal (a signal for excitation) is input into the thin film magnetic head which is in a row bar state by a bonding pad and a probe is moved to scan the thin film magnetic head for observation of the state of a magnetic field generated by a recording head element included in the thin film magnetic head at a position corresponding to a flying height of the magnetic head. Then, not the physical shape of the recording head element but the shape of the generated magnetic field is measured by direct observation through a magnetic force microscope (MFM), a scanning Hall-probe microscope (SHPM) or a scanning magnetoresistance microscope (SMRM) to attain nondestructive inspection of a magnetic effective track width.

That is, measurement of the effective track width which has been inspected so far only in a HGA (head gimbal assembly) state or a pseudo HGA state using a spin stand is allowed in the row bar state by using the magnetic force microscope.

However, in the technique described in Japanese Patent Laid-Open No. 2009-230845, not only the magnetic head element and its vicinity but also the entire surface including its surrounding area are scanned and hence much time is taken for scanning.

### SUMMARY OF THE INVENTION

Accordingly, the present invention aims to provide inspection apparatus and method for magnetic head allowing efficient inspection of the magnetic head.

The present invention has been made in view of the above mentioned disadvantage. Therefore the present invention is configured as follows.

According to one embodiment of the present invention, a signal for excitation is supplied to a connection terminal of a magnetic head which is in a row bar state, a magnetic probe which is disposed on the tip of a cantilever of a magnetic force microscope which is excited at a predetermined frequency is made to fly over the magnetic head and to scan a plurality of scan lines which are arranged at predetermined intervals in parallel with one side of the magnetic head, a magnetic field strength of the magnetic head indicating an excited state of the cantilever is detected during scanning, magnetic field strength profiles of the magnetic field strengths of the scan lines are formed, an effective magnetic field strength profile that brings about a magnetic effective track width of the magnetic head is extracted on the basis of a result of detection of the magnetic field strength, the magnetic effective track width of the magnetic head is obtained on the basis of the effective magnetic field strength profile and a scan for obtaining the magnetic effective track width of the magnetic head is stopped after extraction of the effective magnetic field strength profile.

According to another embodiment of the present invention, in extraction of the effective magnetic field strength profile, a magnetic field strength profile that brings about a maximum value of the magnetic field strength profiles obtained from the respective scan lines, or a magnetic field strength profile that brings about a maximum value of the magnetic effective track widths obtained from the magnetic field strength profiles of the respective scan lines is extracted as the effective magnetic field strength profile.

According to a further embodiment of the present invention, in controlling the scan, a scan range of scan lines to be scanned (a scan range within which scan lines to be scanned are included) is limited on the basis of the magnetic effective track width of the magnetic head which has been already obtained from the same row bar or from another row bar produced in the same lot.

According to a still further embodiment of the present invention, in controlling the scan, the scan range of scan lines to be scanned is limited on the basis of the magnetic effective track width of the magnetic head which has been already obtained from the same row bar or from another row bar produced in the same lot or a maximum value magnetic field strength profile formed by a maximum value of the magnetic field strength profiles obtained from the respective scan lines.

According to a still further embodiment of the present invention, in inspection, the magnetic effective track width of the magnetic head is obtained on the basis of one or a plurality of magnetic field strength profile(s) before and/or behind the effective magnetic field strength profile in addition to the effective magnetic field strength profile.

According to the embodiments of the present invention, it is allowed to provide the inspection apparatus and method for magnetic head allowing efficient inspection of the magnetic head.

### BRIEF DESCRIPTION OF THE DRAWINGS

FIG. 1 is a diagram illustrating an example of a schematic configuration of an inspection apparatus for magnetic head according to an embodiment of the present invention.

FIG. 2 is a diagram illustrating an example of an image obtained by prior art that fully scans a predetermined range including a magnetic head concerned.

FIG. 3 is a diagram illustrating an example that a scan image obtained by scanning the magnetic head in a horizontal (Y) direction in FIG. 2 is graphed as a magnetic field strength profile, illustrating an effective magnetic field strength profile which is maximum in influence of a magnetic field of the magnetic head in magnetic field strength profiles, that is, has a magnetic effective track.

FIG. 4A is a diagram schematically illustrating an example of a magnetic field strength profile in each scan when the full scan illustrated in FIG. 2 has been performed, that is, illustrating an example of the magnetic field strength profiles of the respective scan lines.

FIG. 4B is a diagram schematically illustrating an example of the magnetic field strength profile in each scan when the full scan illustrated in FIG. 2 has been performed, that is, illustrating an example of a maximum value magnetic field strength profile that a maximum value of the magnetic field strength profiles of the respective scan lines forms.

FIG. 5 is a diagram illustrating an embodiment 1, illustrating a scan range for obtaining a magnetic effective track width.

FIG. 6 is a graph illustrating an example of a maximum value magnetic field strength profile in the embodiment 1.

FIG. 7 is a flowchart illustrating an example of a processing flow for obtaining the magnetic effective track width in the embodiment 1.

FIG. 8 is a diagram illustrating an embodiment 2 that limits a scan range of scan lines to be scanned for obtaining the magnetic effective track width.

FIG. 9 is a graph illustrating an example of a scan start position (a start where a scan of scan lines to be scanned is started) and a scan end position (an end position where the scan of the scan lines to be scanned is ended) in each magnetic field strength profile in the embodiment 2.

FIG. 10 is a diagram illustrating an embodiment 3 that further limits the scan range of scan lines to be scanned for obtaining the magnetic effective track width.

FIG. 11 is a diagram illustrating an embodiment 4 that further limits the scan range of scan lines to be scanned for obtaining the magnetic effective track width.

FIG. 12 is a graph illustrating an example of a maximum value magnetic field strength profile in the embodiment 4.

### DETAILED DESCRIPTION OF THE EMBODIMENTS

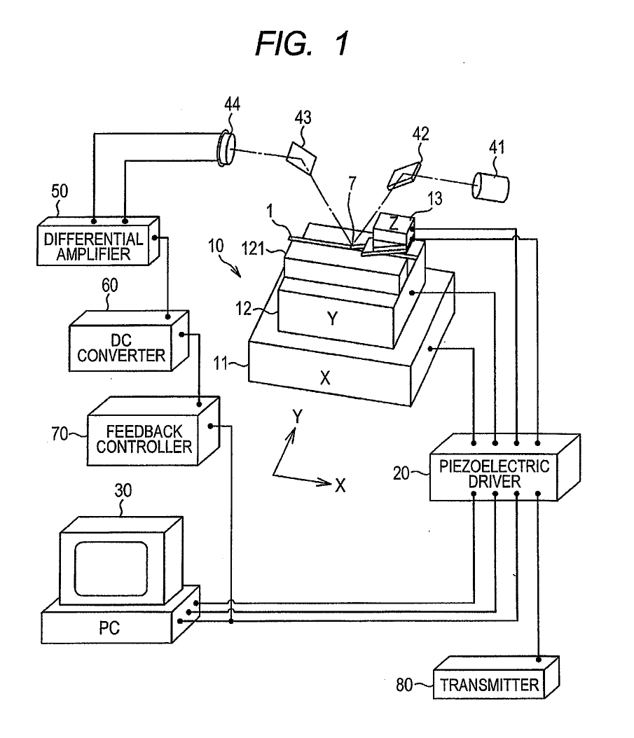

FIG. 1 is a diagram illustrating an example of a schematic configuration of an inspection apparatus for magnetic head according to an embodiment of the present invention. The inspection apparatus for magnetic head illustrated in FIG. 1 allows measurement of a magnetic effective track width of an MR (Magneto Resistive) head, a GMR (Giant Magneto Resistive) head or a TMR (Tunneling Magneto Resistive) head (hereinafter, referred to as the MR head) which is in a row bar (a block that head sliders are arrayed) state in a pre-process of cutting out slider units (chips).

In general, the row bar which has been cut out of a wafer as an elongated block body of about 3 cm to 5 cm has a configuration that about 40 to 60 head sliders are arrayed. The inspection apparatus for magnetic head according to this embodiment is configured to perform predetermined inspection on the row bar 1 as a workpiece. In general, about 20 to 30 row bars are arrayed and contained in a not illustrated tray at predetermined intervals in the minor axis direction. A not illustrated handling robot takes out the row bars 1 one by one from the not illustrated tray and conveys the row bars onto an inspection stage 10. The row bar 1 so conveyed and set on the inspection state 10 is inspected as described in the following.

The inspection state 10 includes an X stage 11 and a Y stage 12 that move the row bar 1 in X and Y directions. One side face of the row bar 1 in the major axis direction is temporarily brought into abutment on a reference plane of the Y stage 12, by which the row bar 1 is positioned. A mount 121 for positioning the row bar 1 is disposed on an upper surface of the Y stage 12. A stepped part that almost matches the shape of the row bar 1 is formed in an upper surface side edge of the mount 121. The row bar 1 is brought into abutment on a bottom and a side face of the stepped part to be set in position. A rear side face (a face opposite to a face on which respective connection terminals of magnetic heads are formed) of the row bar 1 is brought into abutment on a rear face of the stepped part. Since respective abutment faces include reference planes which are in a positional relation that the planes are respectively parallel with a moving direction (the X axis) of the X stage 11 and a moving direction (the Z axis) of a Z stage 13 and are orthogonal to each other, positioning in the X direction and the Z direction is executed by installing the row bar 1 on the stepped part in abutment on the bottom and the side face of the stepped part of the Y stage 12.

Although not illustrated in FIG. 1, a camera for measuring a displacement amount is disposed above the Y stage 12. The Z stage 13 moves a cantilever section 7 of a magnetic force microscope (MFM) in the Z direction. The X stage 11, the Y stage 12 and the Z stage 13 of the inspection stage 10 are respectively configured by using piezoelectric stages. After predetermined positioning has been completed, the row bar 1 is suction-held on the mount 121 and a probe tip of a not illustrated probe card is brought into contact with a terminal on a front side face of the row bar 1. Thus, a coil for recording head of each magnetic head of the row bar 1 enters an excitable state.

A piezoelectric driver 20 drives and controls the X stage 11, the Y stage 12 and Z stage 13 (the piezoelectric stages) of the inspection stage 10. A control section 30 includes a computer for control that includes a monitor-including personal computer (PC) as a basic configuration and controls the piezoelectric driver 30. As illustrated in FIG. 1, the cantilever section 7 whose tip-pointed magnetic probe is disposed on its free end is arranged at a position which is situated above and faces the row bar 1 mounted on the Y stage 12 of the inspection stage 10. The cantilever section 7 is attached to an excitation member disposed under the Z stage 13. The excitation member includes a piezoelectric element and an AC voltage of a frequency which is in the vicinity of a mechanical resonance frequency is applied to the excitation member by application of an excited voltage from the piezoelectric driver 20 to vibrate the magnetic probe vertically.

A displacement detection section includes a semiconductor laser element 41, reflecting mirrors 42 and 43 and a displacement sensor 44 that includes a half-split light detector element. Light emitted from the semiconductor laser element 41 is reflected by the reflecting mirror 42 and is radiated on the cantilever section 7, and then is reflected from the cantilever section 7 toward the reflecting mirror 43. The light reflected by the cantilever section 7 is further reflected by the reflecting mirror 43 and is guided to the displacement sensor 44. A differential amplifier 50 performs predetermined arithmetic processing on a difference signal between two signals which are output from the displacement sensor 44 and outputs the signal to a DC converter 60. That is, the differential amplifier 50 outputs a displacement signal corresponding to the difference between the two signals which are output from the displacement sensor 44 to the DC converter 60. The DC converter 60 includes an RMS-DC converter (Root Mean Squared value to Direct Current converter) that converts the displacement signal output from the differential amplifier 50 into a direct current signal of an effective value.

The displacement signal output from the differential amplifier 50 is a signal corresponding to displacement of the cantilever section 7 and is output as an AC signal because the cantilever section 7 vibrates. The signal which is output from the DC converter 60 is output to a feedback controller 70. The feedback controller 70 outputs a signal which is output from the DC converter 60 to the control section 30 as a signal for monitoring the magnitude of current vibration of the cantilever section 7 and also outputs a signal which is output from the DC converter 60 to the piezoelectric driver 20 as a signal for controlling the Z stage 13 for adjustment of the magnitude of excitation of the cantilever section 7.

The control section 30 monitors the signal output from the feedback controller 70 and controls the Z stage 13 of the piezoelectric driver 20 in accordance with a value of the monitored signal so as to adjust the initial position of the cantilever section 7 before measurement is started. In this embodiment, a head flying height of a hard disk drive is set as the initial position of the cantilever section 7. In addition, the control section 30 performs a process of obtaining a magnetic effective track width of the magnetic head on the basis of data obtained from the feedback controller 70. Although it is preferable that a flying height of the cantilever section 7 be the same as the head flying height, these heights may be different from each other. When these heights are different from each other, the obtained magnetic effective track width is corrected on the basis of the heights.

A transmitter 80 supplies an oscillation signal for exciting the cantilever section 7 to the piezoelectric driver 20. The piezoelectric driver 20 vibrates the cantilever section 7 at a predetermined frequency on the basis of the oscillation signal from the transmitter 80.

Owing to the configuration as mentioned above, a phase difference which is proportional to the strength of a magnetic field that the magnetic head generates occurs in the vibration at the predetermined frequency that the cantilever section 7 has, and the difference is generated between the two signals output from the displacement sensor 44 that includes the half-split light detector element in accordance with the magnitude of the phase difference. Thus, the strength of the magnetic field that the magnetic head generates is found from the difference between the two signals. It is allowed to obtain the effective track width of the magnetic head by making the magnetic head scan as described later while AC-exciting the recording head of the magnetic head. In addition, actual measurement of a ball width (a structural magnetic pole width) of the magnetic head is allowed by inspecting the magnetic head by using as a general MFM without AC-exciting the recording head.

The magnetic head is inspected in the following manner. First, the cantilever section 7 is positioned by the Z stage 13 such that the tip of the magnetic probe of the cantilever section 7 reaches a position corresponding to the head flying height measured from the surface the magnetic head formed on the row bar 1. Next, the magnetic head is two-dimensionally scanned by driving the X and Y stages 11 and 12 to inspect the magnetic head.

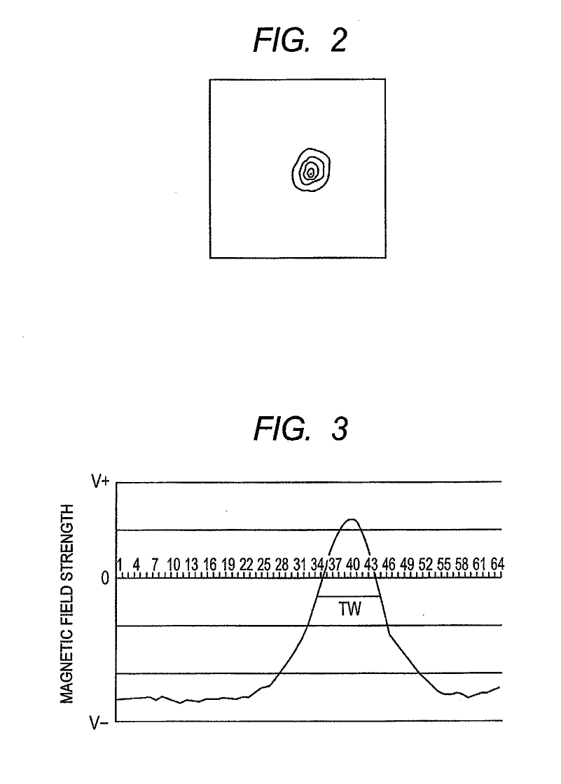

FIG. 2 illustrates an example of an image obtained by the prior art that fully scans a predetermined range including a magnetic head concerned. In a two-dimensional scan, a Y-direction scan line that crosses the magnetic head is scanned in parallel with the short side of the row bar 1, after scanned, a scan (referred to as a shift) is performed at a predetermined interval in the X direction in which the long side of the row bar 1 is oriented, and the above mentioned operations are repeated. In the example in FIG. 2, a white part around the image is a region which is not influenced by the AC excited magnetic field of the magnetic head and a contour line part is a region which is influenced by the AC excited magnetic field of the magnetic head, indicating that it is more influenced by the AC excited magnetic field, that is, the magnetic field of the magnetic head gets stronger as it approaches the center. The magnetic field exhibits a conical shape that a side face gently swells outward three-dimensionally.

FIG. 3 is a diagram illustrating an example that a scan image obtained by scanning the magnetic head in a lateral (Y) direction is graphed as a magnetic field strength profile, illustrating an effective magnetic field strength profile which is maximized in influence of the magnetic field of the magnetic head in magnetic field strength profiles, that is, which is high in possibility that it brings about the most a magnetic effective track width of the magnetic head. The horizontal axis indicates a scan position and the vertical axis indicates an output voltage value (V) of the DC converter 60 corresponding to a magnetic field strength of the magnetic head at each scan position. In this embodiment, a level width across which magnetic field strengths exceeding a certain magnetic field strength are attained is defined as a magnetic effective track width TW as illustrated in FIG. 3. Incidentally, it may sometimes occur that signs (V+ and V−) of the output voltage (V) of the DC converter are reversed depending on measurement conditions.

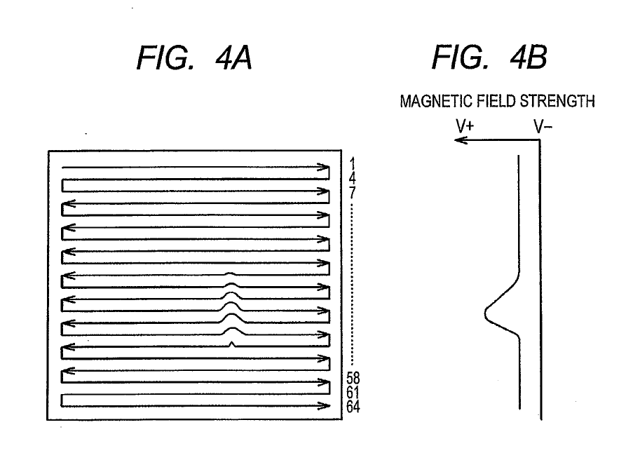

FIG. 4A and FIG. 4B are diagrams schematically illustrating examples of magnetic field strength profiles of respective scan lines obtained when the full scan illustrated in FIG. 2 has been performed. FIG. 4A is a diagram illustrating an example of the magnetic field strength profiles of the respective scan lines, and FIG. 4B is a diagram illustrating an example of a maximum magnetic field strength profile that a maximum value of the magnetic field strength profiles of the respective scan lines forms. Vertically indicated numerals in FIG. 4A are the numbers assigned to the respective scan lines. The same thing also applies to FIG. 6 and FIG. 12 (horizontally indicated). Numerals in FIG. 9 are the numbers indicating scan positions as in FIG. 3.

As illustrated in FIG. 4A, the magnetic field strength profiles of the respective scan lines exhibit almost flat curves which are not influenced by the magnetic field of the magnetic head on the upper side in FIG. 4A, and thereafter a region influenced by the magnetic field is gradually increased. Then, a scan line which is maximized in influence of the magnetic field of the magnetic head illustrated in FIG. 3 is obtained, and thereafter the influence of the magnetic field is gradually reduced and the profiles are again flattened at positions free from the influence of the magnetic field of the magnetic head. In addition, as illustrated in FIG. 4B, the maximum value magnetic field strength profile that the maximum value of the magnetic field strength profiles of the respective scan lines forms also exhibits a shape which is gently angled centering round the scan line where the strength of the magnetic field of the magnetic head illustrated in FIG. 2 is maximized.

The magnetic effective track width is obtained using data on the effective magnetic field strength profile illustrated in FIG. 4A or the magnetic field strength profile indicating the maximum value of the maximum value magnetic field strength profile illustrated in FIG. 4B, or data on one or a plurality of magnetic field strength profiles before and/or behind the above profile(s) including the above profile(s). Therefore, it is not required to obtain the magnetic effective track width after fully scanning the predetermined range of the magnetic head illustrated in FIG. 2 and obtaining all pieces of data as in the prior art.

From the above mentioned conception, a scan in the Y direction is performed until the data on the effective magnetic field strength or the magnetic field strength profile indicating the maximum value of the maximum value magnetic field strength profile is obtained and after that the scan is stopped in the present embodiment. Here, that the scan is stopped means to stop the scan for obtaining the data on the effective magnetic field strength profile or the magnetic field strength profile indicating the maximum value of the maximum value magnetic field strength profile and does not mean to stop a scan in the y direction and a shift in the x direction for inspecting the next magnetic head. In addition, in many cases, the effective magnetic field strength profile matches the magnetic field strength profile indicating the maximum value of the maximum value magnetic field strength profile. That is, a scan line that exhibits the effective magnetic field strength profile also exhibits the magnetic field strength profile indicating the maximum value of the maximum value magnetic field strength profile.

### Embodiment 1

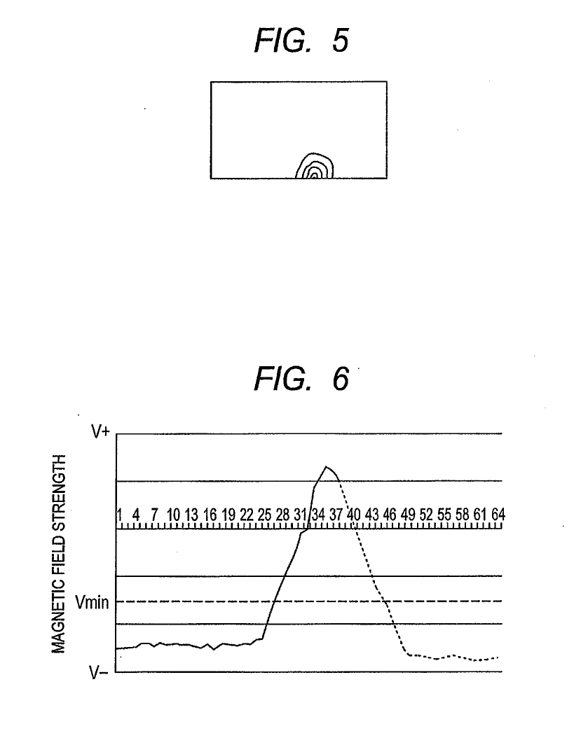

FIG. 5 is a diagram illustrating an embodiment 1, illustrating a scan range for obtaining the magnetic effective track width TW. FIG. 6 illustrates an example of the maximum value magnetic field strength profile corresponding to the profile illustrated in FIG. 4B in the embodiment 1.

In the embodiment 1, the shift in the X direction is performed until the maximum value magnetic field strength profile obtains the maximum value. Actually, further several scan lines are scanned in order to decide that a currently obtained value is the maximum value, that is, to confirm that the value shows a downward trend as illustrated in FIG. 6. In the example illustrated in FIG. 6, the 36-th scan line brings about the maximum value and the magnetic effective track width TW is obtained from the magnetic field strength profile of the 36-th scan line corresponding to that in FIG. 3.

In the example illustrated in FIG. 6, while the number of scan lines that have been scanned is 64 as indicated by the solid and broken lines in the prior art, the number of scan lines that have been scanned is 37 as indicated by the solid line in the embodiment 1. Therefore, when evaluation is made in terms of a scanning system that the next scan is performed in the opposite direction from a position where the scan concerned is completed after completion of the scan concerned, a reduction in scan process time of 42% is promoted.

Since a position where a two-dimensional scan is started is determined on the basis of the production accuracy of the magnetic head in the row bar 1, a scan of scan lines is started slightly early in order to surely catch the scan start position. Therefore, a reduction rate of the scan time of about 40% to 50% is attained in the embodiment 1. The more the number of scan lines corresponding to a flat part which is not influenced by the magnetic field of the magnetic head is increased, the more the reduction rate of the scan time is increased. Incidentally, a scan line interval (a shift interval) and a data interval in the magnetic field strength profile depend on desirable measurement accuracy.

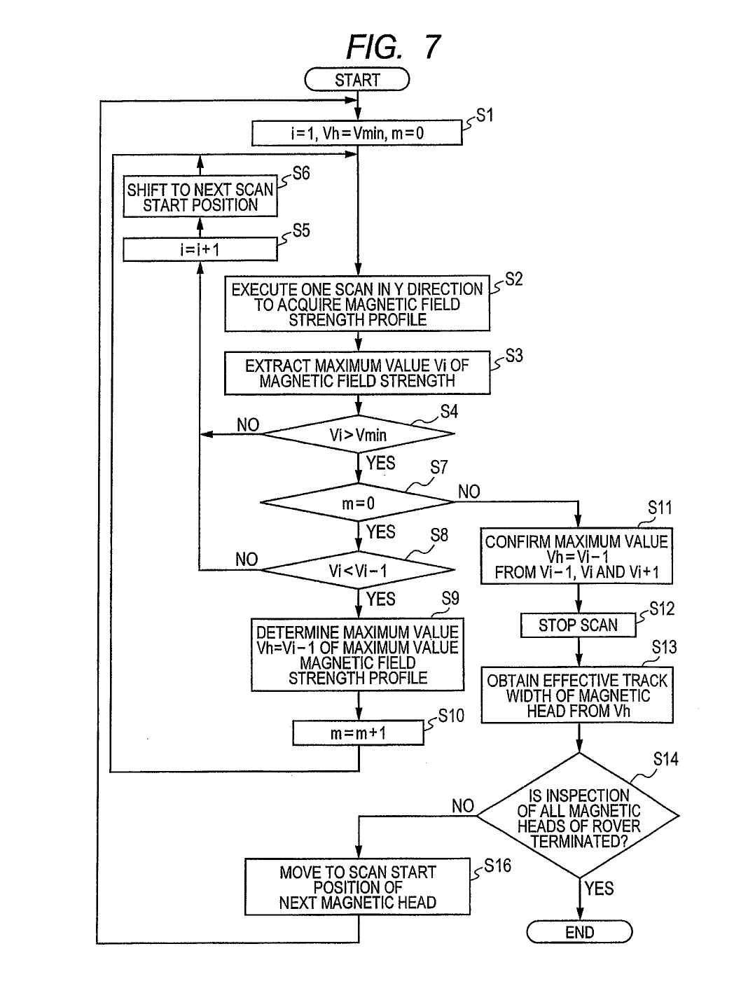

FIG. 7 is a diagram illustrating in detail an example of a process flow for obtaining the magnetic effective track width in the embodiment 1.

First, in step 1 (S1), an initial value of each index is set. i is the scan line number in FIG. 4A. Vi is a magnetic field strength in each scan, that is, a maximum value of obtained voltages. m is an index indicating that a maximum value Vh of a maximum value magnetic field strength profile has been obtained.

Next, a scan in the X-direction is performed to acquire the magnetic field strength profile for each scan line (S2) and to extract the maximum value Vi in the obtained magnetic field strength profiles (S3). Since the flat part which is not influenced by the magnetic field of the magnetic head is scanned in the beginning, noise is extracted and the maximum value Vi is not stabilized. Vmin is set as the maximum value Vh of the maximum value magnetic field strength profile until the maximum value Vi has the stabilized value Vmin (S4). When Vi is less than Vmin, the shift is made to the next scan start position in the X direction (S5 and S6).

When the Vi is larger than Vmin, search for the maximum value Vh of the maximum value magnetic field strength profile is started (S7 to S9). If the maximum value Vh of the maximum value magnetic field strength profile has been already obtained as a result of the previous scan by performing the process in S10, m would indicate 1. Therefore, it is confirmed whether the maximum value Vh of the maximum value magnetic field strength profile has already been obtained in S7.

When m=0, that is, the maximum value of the maximum value magnetic field strength profile is not yet obtained, the maximum values Vi−1 and Vi of the magnetic field strength profiles in the previous and this time scans are compared with each other to determine whether the maximum value of the magnetic field strength profile shows a downward trend. If not, the process proceeds to S5 for further scans. If yes, the maximum value Vi−1 of the magnetic field strength profile in the previous scan is regarded as the maximum value Vh of the maximum value magnetic field strength profile (S9) and 1 is added to the index m (S10). The process proceeds to S2 for performing one more scan.

When m=1 in S7, the maximum value Vh=Vi−1 of the maximum value magnetic field strength profile is confirmed in S11, the scan for obtaining the maximum value Vh is stopped (S12), and the magnetic effective track width TW is obtained from the magnetic field strength profile from which the value Vh has been obtained (S13).

Then, whether inspection of all the magnetic heads in the row bar 1 has been completed is determined (S14). When the process is not completed, the probe is moved to the scan start position of the next magnetic head (S18) and then the process returns to S1 to perform again a series of processes. When the process is completed, execution of the series of processes is terminated.

Although the position where the scan is stopped is determined depending on the maximum value magnetic field strength profile in the embodiment 1, the track width may be calculated per magnetic field strength profile and the position where the scan is stopped may be determined depending on a reduction in track width. However, from the viewpoint of facilitation of data processing, it is rather favorable that simply the maximum value of the magnetic field strength profiles be monitored without calculating the track width per magnetic field strength profile.

Incidentally, the magnetic effective track width TW may be obtained also by using data on the magnetic field strength profiles before and behind the effective magnetic field strength profile and/or the magnetic field strength profile indicating the maximum value of the maximum value magnetic field strength profile, in addition to the data on the effective magnetic field strength profile or the magnetic field strength profile indicating the maximum value of the maximum value magnetic field strength profile.

In addition, although the scan is performed still after the maximum value Vh of the maximum value magnetic field strength profile has been obtained in the embodiment 1, the scan may be stopped immediately after the maximum value has been obtained.

### Embodiment 2

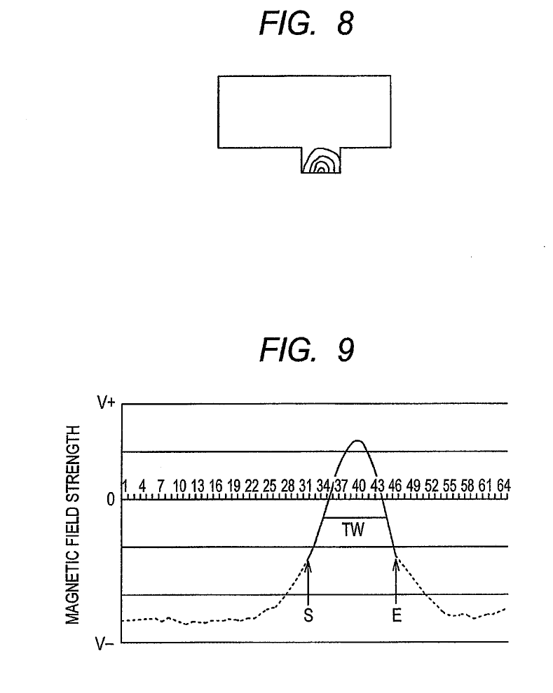

FIG. 8 is a diagram illustrating an embodiment 2 configured to limit the scan range of scan lines to be scanned for obtaining the magnetic effective track width.

About 40 to 60 magnetic heads are formed in the row bar 1. If a plurality of magnetic heads is inspected on the basis of the method according to the embodiment 1, a start position S and an end position E in respective magnetic field strength profiles which is necessary for obtaining the effective track width are obtained as illustrated in FIG. 9. Therefore, after several scan lines are scanned, only the range between the positions S and E is scanned. In case of the row bars 1 produced in the same lot, the scan range of scan lines to be scanned of one row bar 1 may be limited on the basis of a scan result of another row bar 1 produced in the same lot.

In the embodiment 2, the scan time is more reduced than in the embodiment 1.

### Embodiment 3

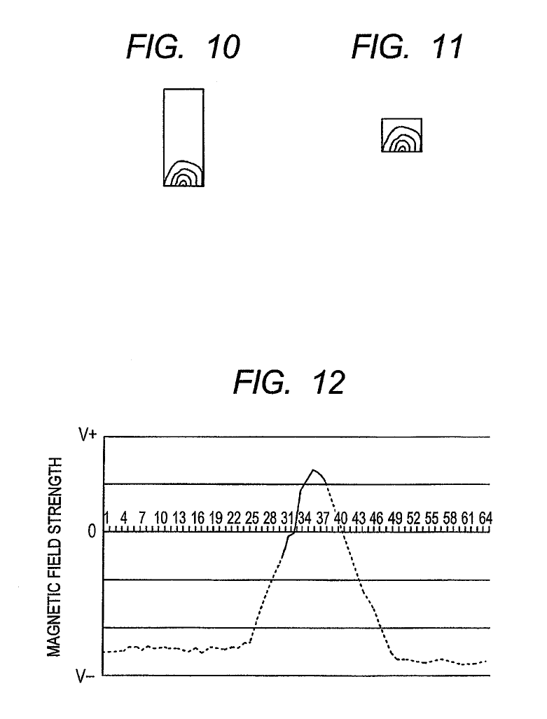

FIG. 10 is a diagram illustrating an embodiment 3 configured to more limit the scan range for obtaining the magnetic effective track width TW. In the embodiment 3, the conception of the embodiment 2 is further developed so as to reduce the scan range in the same manner as in the embodiment 2 also on the flat part in the X direction.

In the embodiment 3, if in a two-dimensional scan, the start position S and the end position E of the scan lines to be scanned are respectively set on the 30-th and 46-th scan lines as illustrated in FIG. 9, the number of scan lines included within the scan range will be limited to 17. Thus, the scan time is reduced to 17/64≈26%. The conception of the embodiment 2 may be also applied to the scan of the row bars 1 produced in the same lot.

### Embodiment 4

FIG. 11 is a diagram illustrating an embodiment 4 configured to further limit the range of scan lines to be scanned for obtaining the magnetic effective track width TW. In the embodiment 4, since the interval between the magnetic heads is evaluated by inspecting the plurality of magnetic heads as in the embodiment 2, the start position of the scan line to be scanned is further delayed. FIG. 12 is a diagram illustrating an example of the maximum value magnetic strength profile in the embodiment 4, in which the solid line indicates the range of the scan lines that have been scanned for obtaining the magnetic field strength profile. As a result, the scan time is more reduced than that in the embodiment 3. The conception of the embodiment 2 may be also applied to the scan of the row bars 1 produced in the same lot.

Although in the above mentioned embodiment, the scan is performed in the Y direction and the shift is performed in the X direction, the scan may be performed in the X direction and the shift may be performed in the Y direction.

According to the above mentioned embodiments 1 to 4, it is allowed to provide the inspection apparatus and method for magnetic head allowing to more reduce the scan time, to more increase the throughput and to inspect the magnetic head element more efficiently than ever.

What is claimed is:

1. An inspection apparatus for magnetic head, comprising:
a cantilever section of a magnetic force microscopy including a magnetic probe on the tip and oscillated at a predetermined frequency;
a probe section supplying a signal for excitation to a connection terminal of a magnetic head which is in a row bar state;
a scan control section making the magnetic probe fly over the magnetic head to make the magnetic probe scan a plurality of scan lines at predetermined intervals in parallel with one side of the magnetic head;
a detection section detecting a magnetic field strength of the magnetic head indicating an excited state of the cantilever section during the scan;
a magnetic field strength profile formation section forming magnetic field strength profiles of the magnetic field strengths of the scan lines;
an effective magnetic field strength profile extraction section extracting an effective magnetic field strength profile that brings about a magnetic effective track width of the magnetic head on the basis of a result of detection by the detection section;
a magnetic head inspection section obtaining the magnetic effective track width of the magnetic head on the basis of the effective magnetic field strength profile; and
a scan stop section stopping a scan for obtaining the magnetic effective track width of the magnetic head after extraction of the effective magnetic field strength profile by the scan control section.

2. The inspection apparatus for magnetic head according to claim 1,
wherein the effective magnetic field strength profile extraction section extracts a magnetic field strength profile that brings about a maximum value of the magnetic field strength profiles obtained from the respective scan lines, or a magnetic field strength profile that brings about a maximum value of the magnetic effective track widths obtained from the magnetic field strength profiles of the respective scan lines as the effective magnetic field strength profile.

3. The inspection apparatus for magnetic head according to claim 1,
wherein the scan control section limits a scan range of the scan lines to be scanned on the basis of the magnetic effective track width of the magnetic head which has been already obtained from the same row bar or from another row bar produced in the same lot.

4. The inspection apparatus for magnetic head according to claim 2,
wherein the scan control section limits a scan range of the scan lines to be scanned on the basis of the magnetic effective track width of the magnetic head which has been already obtained from the same row bar or from another row bar produced in the same lot.

5. The inspection apparatus for magnetic head according to claim 1,
wherein the scan control section limits a scan range of the scan lines to be scanned on the basis of the magnetic effective track width of the magnetic head which has been already obtained from the same row bar or from another row bar produced in the same lot or a maximum value magnetic field strength profile formed by a maximum value of the magnetic field strength profiles obtained from the respective scan lines.

6. The inspection apparatus for magnetic head according to claim 2,
wherein the scan control section limits a scan range of the scan lines to be scanned on the basis of the magnetic effective track width of the magnetic head which has been already obtained from the same row bar or from another row bar produced in the same lot or a maximum value magnetic field strength profile formed by a maximum value of the magnetic field strength profiles obtained from the respective scan lines.

7. The inspection apparatus for magnetic head according to claim 1,
wherein the inspection section obtains a magnetic effective track width of the magnetic head on the basis of one or a plurality of magnetic field strength profile(s) before and/or behind the effective magnetic field strength profile in addition to the effective magnetic field strength profile.

8. The inspection apparatus for magnetic head according to claim 2,
wherein the inspection section obtains a magnetic effective track width of the magnetic head on the basis of one or a plurality of magnetic field strength profile(s) before and/or behind the effective magnetic field strength profile in addition to the effective magnetic field strength profile.

9. An inspection method for magnetic head, comprising:
the supplying step of supplying a signal for excitation to a connection terminal of a magnetic head which is in a row bar state;
the scan controlling step of making a magnetic probe fly which is disposed on the tip of a cantilever of a magnetic force microscope which is excited at a predetermined frequency over the magnetic head to make the magnetic probe scan a plurality of scan lines at predetermined intervals in parallel with one side of the magnetic head;
the detecting step of detecting a magnetic field strength of the magnetic head indicating an excited state of the cantilever during the scan;
the magnetic field strength profile forming step of forming magnetic field strength profiles of the magnetic field strengths of the scan lines;
the effective magnetic field strength profile extracting step of extracting an effective magnetic field strength profile that brings about a magnetic effective track width of the magnetic head on the basis of a result of detection in the detecting step;
the magnetic head inspecting step of obtaining the magnetic effective track width of the magnetic head on the basis of the effective magnetic field strength profile; and
the scan stopping step of stopping a scan for obtaining the magnetic effective track width of the magnetic head after extraction of the effective magnetic field strength profile in the scan controlling step.

10. The inspection method for magnetic head according to claim 9,
wherein, in the effective magnetic field strength profile extracting step, a magnetic field strength profile that brings about a maximum value of the magnetic field strength profiles obtained from the respective scan lines, or a magnetic field strength profile that brings about a maximum value of the magnetic effective track widths obtained from the magnetic field strength profiles of the respective scan lines is extracted as the effective magnetic field strength profile.

11. The inspection method for magnetic head according to claim 9,
wherein, in the scan controlling step, a scan range of the scan lines to be scanned is limited on the basis of the magnetic effective track width of the magnetic head which has been already obtained from the same row bar or from another row bar produced in the same lot.

12. The inspection method for magnetic head according to claim 10,
wherein, in the scan controlling step, a san range of the scan lines to be scanned is limited on the basis of the magnetic effective track width of the magnetic head which has been already obtained from the same row bar or from another row bar produced in the same lot.

13. The inspection method for magnetic head according to claim 9,
wherein, in the scan controlling step, a scan range of the scan lines to be scanned is limited on the basis of the magnetic effective track width of the magnetic head which has been already obtained from the same row bar or from another row bar produced in the same lot or a maximum value magnetic field strength profile formed by a maximum value of the magnetic field strength profiles obtained from the respective scan lines.

14. The inspection method for magnetic head according to claim 10,
wherein, in the scan controlling step, a scan range of the scan lines to be scanned is limited on the basis of the magnetic effective track width of the magnetic head which has been already obtained from the same row bar or from another row bar produced in the same lot or a maximum value magnetic field strength profile formed by a maximum value of the magnetic field strength profiles obtained from the respective scan lines.

15. The inspection method for magnetic head according to claim 9,
wherein, in the inspecting step, the magnetic effective track width of the magnetic head is obtained on the basis of one or a plurality of magnetic field strength profile(s) before and/or behind the effective magnetic field strength profile in addition to the effective magnetic field strength profile.

16. The inspection method for magnetic head according to claim 10,
wherein, in the inspecting step, the magnetic effective track width of the magnetic head is obtained on the basis of one or a plurality of magnetic field strength profile(s) before and/or behind the effective magnetic field strength profile in addition to the effective magnetic field strength profile.
